(19) United States
(12) Patent Application Publication
(10) Pub. No.: US 2024/0428226 A1
(43) Pub. Date: Dec. 26, 2024

(54) ELECTRIC VEHICLE SUPPLY EQUIPMENT EMBEDDED PAYMENT READER

(71) Applicant: Loop Global Inc., El Segundo, CA (US)

(72) Inventors: Dustin Cavanaugh, Marina Del Rey, CA (US); Son Lam Dang, Hawthorne, CA (US)

(21) Appl. No.: 18/340,580

(22) Filed: Jun. 23, 2023

(51) Int. Cl. G06Q 20/34; B60L 53/30

(52) U.S. Cl. CPC G06Q 20/341; B60L 53/30; G06Q 20/352

(57) ABSTRACT

The present disclosure generally relates to an electric vehicle supply equipment (EVSE) payment reader, and in particular, to a modular, outside-in, improved design and approach to installing and securing a contact payment reader within a payment reader embedded with an EVSE. An electric vehicle supply equipment (EVSE) comprises a housing; a port disposed in at least one surface of the housing; and a payment reader disposed within the housing via the port, wherein the payment reader is mechanically removable from an exterior of the housing using a security tool.

### BACKGROUND

### 1. Technical Field

The present disclosure generally relates to an electric vehicle supply equipment (EVSE) payment reader, and in particular, to a modular, outside-in, improved design and approach to installing and securing a contact payment reader within a payment reader embedded with an EVSE.

### 2. Introduction

Electric vehicles (EV), including but not limited to electric battery powered vehicles, and battery powered hybrid vehicles, etc. include charge storage devices (batteries) that must be periodically recharged. EVs are sometimes charged using a standard home outlet (e.g., a 120-volt outlet). However, it may take several hours (e.g., eight or more hours) to completely charge an electric vehicle using a standard home outlet. As EV usage continues to increase, specialized charging setups or charging stations are becoming more common. Such stations can be used to charge EVs at a much faster rate than conventional 120-volt outlets. Charging stations, sometimes referred to as Electric Vehicle Service Equipment (EVSE), are typically wired hardwired directly to power lines that supply power to the charging site. Typically, an EVSE consists of a dispenser that connects to the electric vehicle via a charging cable, and power conversion electronics that are housed in the dispenser and/or a separate cabinet or housing. Dispensers may be in designated charging locations (e.g., similar to locations of gas stations), such as adjacent to parking spaces (e.g., public parking spaces and/or private parking spaces), etc. In some cases, EVSE's may require payment from users in exchange for delivered power or other services.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail using the accompanying drawings in which:

FIG. 1 illustrates an example electric vehicle (EV) charging system, including an Electric Vehicle Supply Equipment (EVSE) device, according to some examples of the present disclosure;

FIG. 2 illustrates an exploded view of a contact reader portion of an example payment card reader, according to some examples of the present disclosure;

FIG. 3 illustrates an exploded view of a contactless reader portion of an example payment card reader, according to some examples of the present disclosure;

FIG. 4 illustrates an example contact reader, according to some examples of the present disclosure;

FIG. 5 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

As electric vehicles (EV) are becoming increasingly popular, there is an increasing need for Electric Vehicle Service Equipment (EVSE) devices to accommodate charging at different locations. EVSE's can be located anywhere that vehicle charging can be performed, such as adjacent to vehicle stalls in public or private parking areas. Some EVSE's can require payment from the user in exchange for the power delivered to the EV. In some examples, state and local regulations can establish certain requirements related to the payment processing associated with the EVSE's. For example, the California Air Resource Board (CARB) requires credit card chip readers and contactless payment card readers to be available to users of EVSE's.

Payment information for EV charging may be received from the user via a user device (for example, a wireless device such as a smartphone) that is configured to communicate directly with the EVSE. In some examples, payment via a wireless device or smartphone can be accomplished without the use of a credit card chip reader or a contactless payment card reader. Therefore, in some cases, exclusively providing this method of payment via a wireless device or smartphone may not satisfy the CARB requirement that credit card chip readers and contactless payment card readers be available to users of EVSE's for payment. In some examples, a kiosk can therefore be located near an EVSE, or a group of multiple EVSE's, to accommodate payment via a credit card chip reader and a contactless payment card reader. However, various problems can be encountered by providing a single payment kiosk to service payment for a group of EVSE's.

In some examples, a single payment kiosk configured to accept payment for multiple EVSE's can result in long wait times for users that are lined up at the kiosk waiting for other users to complete their payment. In other examples, a single payment kiosk can be difficult for a user to find if it is not proximate to the EVSE that the user has chosen. As such, providing a single payment kiosk for multiple EVSE's can increase the likelihood of payment and/or processing errors, such as when a user attempts to associate the payment with a specific EVSE that the software cannot locate due to software problems, or an error can occur during batching of the payment data. In some examples, if the single payment kiosk becomes inoperable for any reason, none of the EVSE's associated with the payment kiosk may be available to users wishing to pay with physical credit cards. A single payment kiosk can be enticing to a thief to tamper with and attempt to steal credit card information or other valuable data since all the data is located in a single location. A single payment kiosk can be accessed for payment by large numbers of people over time, which can increase the physical wear and tear of the credit card chip reader, thereby leading to more errors and an increased need for maintenance and upkeep. Further, these payment kiosks can be difficult to install, difficult to update, and difficult to modify due to the layout and design of the various physical components.

Aspects of the disclosed technology address the foregoing issues by providing solutions for embedding a card reader directly into an EVSE. In some approaches, the individual payment card readers can be designed in a modular fashion that allows them to be easy to manufacture, easy to service, and convenient for users to access and use. By embedding the payment card reader into the EVSE, users can directly transact with the EVSE without needing a mobile device or smartphone (or a cellular signal). In some examples, the embedded payment card reader can interface and communicate directly with the EVSE, and in some configurations can receive electrical power from the EVSE. Further, embedding the payment card reader into the EVSE can also make it easier for the user to locate than the single payment kiosk described previously.

Depending on the desired configuration, the embedded payment card reader can include a contact payment card reader and/or a contactless payment card reader (in order to satisfy the CARB requirement, for example). One important aspect of the disclosed technology is the modular, “outside-in,” approach to installing and securing the contact payment card reader portion within the embedded payment card reader. In this context, “outside-in” can mean that the contact payment card reader portion can be inserted (and also removed) from the housing of the embedded payment card reader from the outside (e.g., the embedded payment card reader does not need to be opened in order to access the contact payment card reader portion). This outside-in approach can allow for more working space for authorized personnel (such as technicians, for example) to fasten the contact payment card reader into place, rather than maneuvering tools in a tight space which can lead to inadvertent damage to sensitive circuit boards. As explained in more detail below, in order to service a contact payment card reader, authorized personnel can simply turn off the power to the EVSE, remove a shielding cover, unfasten the one or more security screws, pull out the contact payment card reader, and detach a single connector. In some examples, when authorized personnel intends to insert a refurbished or new contact payment card reader into the embedded payment card reader, the authorized personnel can simply complete these steps in reverse. Additionally, in order to streamline production and field servicing of both the contact and contactless payment readers, the contact and contactless payment readers can be detached from one another within the embedded individual payment card readers. The detached nature of the readers allows more flexibility in subcomponent layouts and consideration for production assembly.

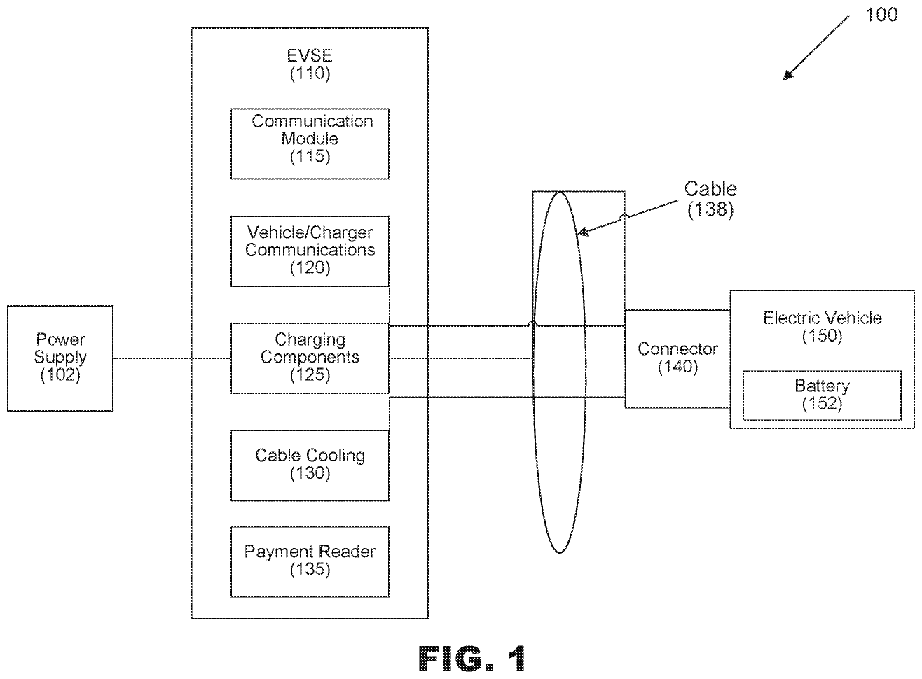

FIG. 1 illustrates an example electric vehicle (EV) charging system 100 that includes an electric vehicle supply equipment (EVSE) 110. System 100 is configured to deliver power from an AC source (e.g., AC power supply 102), to EV 150 via EVSE 110. For example, EVSE 110 can connect to EV 150 through connector 140 of cable 138. EV 150 can be virtually any vehicle that includes a rechargeable battery 152 that powers vehicle propulsion. For example, EV 150 may be an all-EV that uses one or more electric motors powered from the battery system. Alternatively, EV 150 may be a hybrid vehicle that can use a combustion engine and one or more electric motors for propulsion. By way of example, EV 150 may include an automobile, a truck, a bus, a train, an aircraft, a ship, or a tank, or the like. Additionally, battery 152 can include one or more charge storage cells, such an array of batteries, without departing from the scope of the disclosed technology.

In operation, EVSE 110 supplies power to battery 152 through cable 138. Power management is performed by EVSE 110 using charging components 125 that manage charging of battery 152. Charging components 125 can include switches/relays, meter(s), and other electronics for managing charging of EVs. By way of example, charging components 125 may be configured to deliver direct current (DC) power or alternating current (AC) power to EV 150, depending on the desired implementation. Charging components 125 may also include multiple power connections to charge multiple batteries of EV 150 simultaneously and/or at different current rates and/or voltages.

To initiate a charging session, EVSE 110 includes vehicle/charger communications 120 that allows the EVSE 110 to communicate charging parameters and status with EV 150. For instance, vehicle/charger communications 120 may handle communication according to the J1772 standard, the CHAdeMO standard, and/or other communication standards. In some instances, payment for charging services may be initiated using a user or vehicle identifier that is received by vehicle/charger communications 120 from EV 150. In other approaches, payment information for vehicle charging may be received from the user, for example, via a user device (not illustrated), such as a wireless device (or smartphone) that is configured to communicate directly with EVSE 110, via communication module 115, or by receiving payment information directly from a payment card (such as a credit card), via payment reader 135.

Irrespective of how payment information is received by EVSE 110, payment settlement can be facilitated by communication module 115. In such approaches, the user or vehicle identifier (or other payment processing information) can be communicated by EVSE 110 to one or more third-party servers or systems, via communication module 115, to settle the transaction.

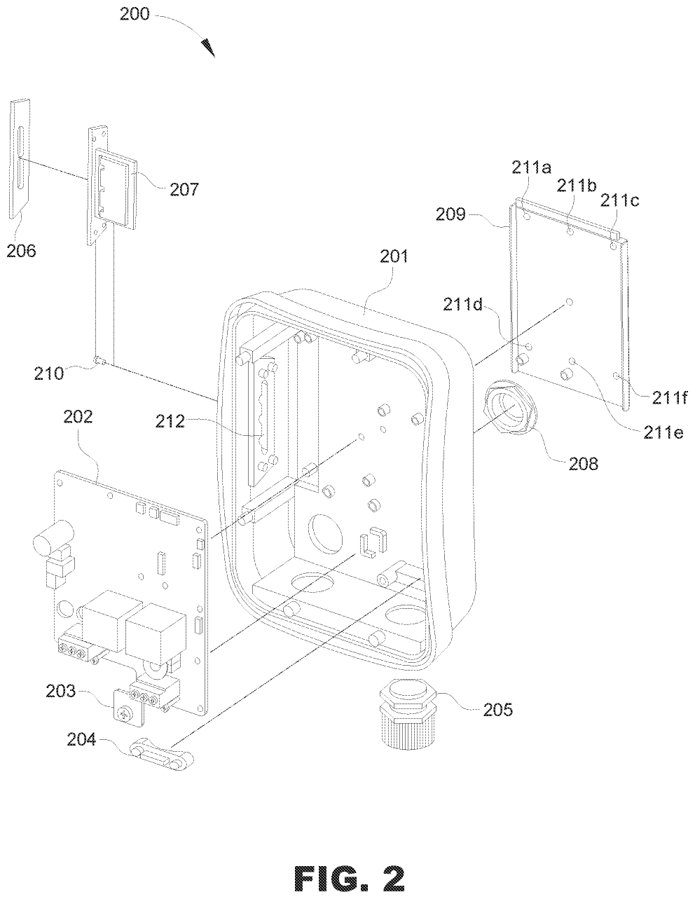

Turning to FIG. 2, as discussed above, in some scenarios it can be preferable to embed individual payment card readers directly onto each EVSE. In some examples, the individual payment card readers can include both a contact payment card reader as well as a contactless payment card reader. In order to streamline production and field servicing of both the contact and contactless payment readers, the contact and contactless payment readers can be detached from one another within the embedded individual payment card readers. The detached nature of the readers allows more flexibility in subcomponent layouts and consideration for production assembly. Additionally, as explained in relation to FIG. 2, the outside-in design and layout of the contact payment reader (see contact reader 207 described below) together with the detached nature results in the contact payment reader being easier to install and service (among other things) as well as provides additional protection again unwanted tampering.

FIG. 2 illustrates an exploded view of a contact reader portion of an example payment card reader 200. Payment card reader 200 is one example of a payment card reader that can be embedded into an EVSE (such as EVSE 110, for example) to permit users to provide payment for power and/or services provided by EVSE 110. As illustrated in FIG. 2, in some examples, payment card reader 200 can be mounted to EVSE 110, using back mount bracket 209, via security screws insertable through screw holes 211a, 211b, 211c, 211d, 211e, 211f. Back mount bracket 209 can attach to a housing 201 in the manner shown in FIG. 2. A bushing 208 can be mounted to the housing 201 as shown in FIG. 2. Bushing 208 can be a removable cylindrical lining used to limit the size of the opening, resist abrasion, or serve as a guide, among other uses. FIG. 2 also illustrates an example cable gland 205 insertable into housing 201. Cable gland 205 can be a cord grip, a cable strain relief, a cable connector or a cable fitting. FIG. 2 also shows a safety board 202 (including dip switch 203 in some examples) that can be mounted within housing 201. A cable mount 204 can also be mounted within housing 201 as shown in FIG. 2.

Continuing with FIG. 2, a contact reader 207 for reading credit cards can be inserted into the housing 201 through the slot 212. In some examples, the contact reader 207 can be secured to the housing 201 using one or more security screws 210. Because the contact reader 207 can be easily inserted into the interior of housing 201 through slot 212 during installation, the contact reader 207 can also be easily removed from the housing 201 (by removing the one or more security screws 210) for subsequent servicing, repairing, updating, replacing, or any other need. In some examples, the one or more security screws 210 can only be removed by use of a security tool designed to mate with the one or more security screws 210. Therefore, while contact reader 207 can be easily removed from the housing 201 for legitimate purposes by authorized personnel in possession of a security tool, contact reader 207 can be secure from unauthorized personnel (such as a thief, for example) lacking a security tool due to the one or more security screws 210 that secure the contact reader 207 within the housing 201.

This modular, outside-in, approach to installing and securing contact reader 207 within the housing 201 of payment card reader 200 provides for both easy installation and servicing by authorized personnel, while also providing security against unauthorized personnel accessing the contact reader 207. In some examples, this outside-in approach can allow for more working space for authorized personnel (such as technicians for example) to fasten the contact reader 207 into place, rather than maneuvering tools in a tight space which can lead to inadvertent damage to sensitive circuit boards. In addition to the one or more security screws 210, a shielding cover 206 can also be placed over the contact reader 207 as illustrated in FIG. 2. In some examples, placement of the shielding cover 206 can also provide an extra layer of protection in deterring unauthorized personnel from accessing card reader 207. Tampering with the shielding cover 206 can cause the payment card reader 200 to cease operation and/or notify authorized personnel of an attempt to tamper with the payment card reader 200. In order to service the contact reader 207, authorized personnel can simply turn off the power to the EVSE, remove shielding cover 206, unfasten the one or more security screws 210, pull out the contact reader 207, and detach a single connector (not shown in FIG. 2). In some examples, when authorized personnel intends to insert a refurbished or new contact reader 207 into housing 201, the authorized personnel can complete these steps in reverse.

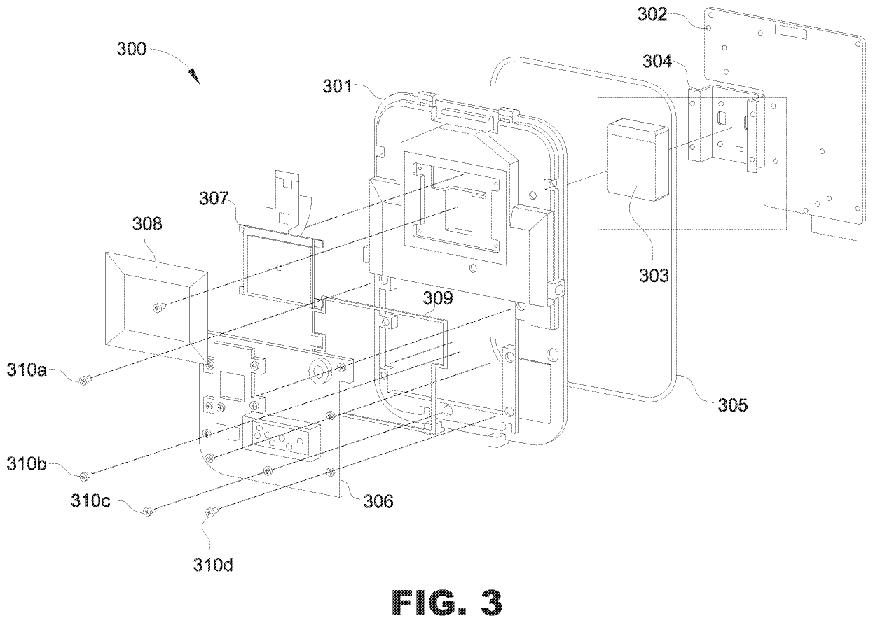

FIG. 3 illustrates an exploded view of a contactless reader portion of an example payment card reader 300. As described above, payment card reader 300 is one example of a payment card reader that can be embedded into an EVSE (such as EVSE 110, for example) to permit users to provide payment for power and/or services provided by EVSE 110. As illustrated in FIG. 3, a near-field communication (NFC) reader 303 can be positioned into an NFC reader bracket 304 located on a network board 302. NFC reader 303 can be used to read payment data from credit card (or any other NFC-equipped payment card) positioned in proximity to the NFC reader 303 for payment of power and/or services provided by EVSE 110. In some scenarios, the assembly of the NFC reader 303 positioned within an NFC bracket 304 located on a network board 302 can be secured to a middle cover 301 encompassed by a waterproof rubber component 305 that can be positioned within housing 201 (shown in FIG. 2).

In addition to the NFC reader 303, FIG. 3 also shows LCD screen 307 that can be mounted into middle cover 301 and covered by LCD protector 308. In some examples, LCD screen 307 can communicate information to a user before, during, or after payment to an EVSE. For example, LCD screen 307 can communicate to a user that the payment has been accepted, the payment has been declined, there was an error reading, or an error processing the payment information, among any other information that may be useful to a user when attempting to make payment to an EVSE. In some examples, the LCD protector 308 can be made of a clear material that permits a user to see the information displayed on the LCD screen 307 clearly, while also being durable enough to protect the LCD screen 307 from damage that may occur due to weather as well as regular wear and tear, among other reasons. Circuit board 306 can be surrounded by a waterproof rubber cover 309 and mounted into middle cover 301 as shown in FIG. 3. Circuit board 306 can be mounted to middle cover 301 by security screws 310a, 310b, 310c, and 310d. It is understood that the number of security screws used to secure circuit board 306 to middle cover 301 can be more or less than the four security screws illustrated in FIG. 3.

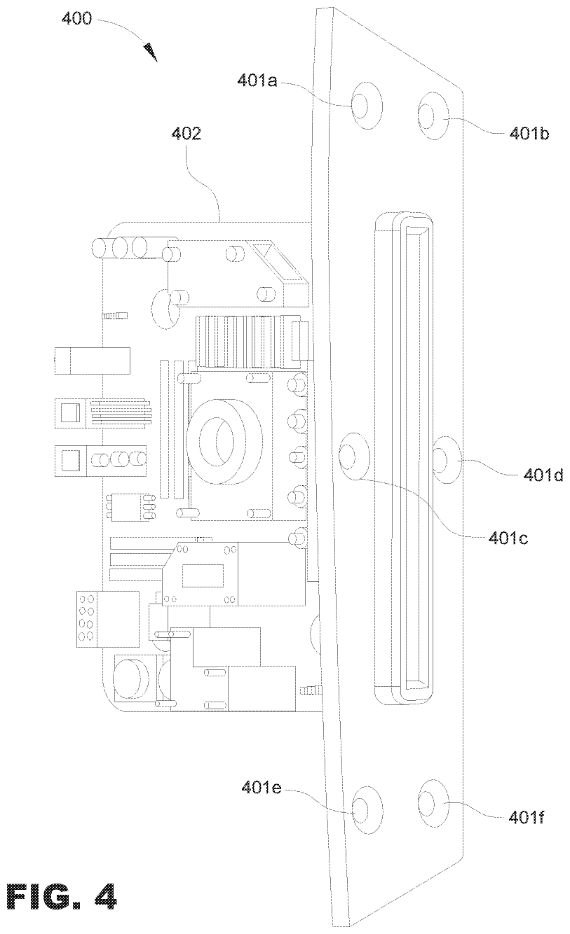

FIG. 4 illustrates an example contact reader 400 (similar to contact reader 207 described above in relation to FIG. 2). In some examples, contact reader 400 can include circuit board 402 and can be inserted into the housing of the embedded payment reader (e.g., housing 201 via slot 212 in FIG. 2) in order to read payment data from user payment cards. The contact reader 400 can be secured to the housing of the embedded payment reader (e.g., housing 201 in FIG. 2) using one or more security screws inserted through screw holes 401a-401f. It is understood that the number of security screws and the number of screw holes can be more or fewer than the number illustrated in FIG. 4. As discussed previously, since the contact reader 400 can be easily inserted into the interior of the embedded payment reader through a slot (e.g., slot 212 in FIG. 2) during installation, the contact reader 400 can also be easily removed from the embedded payment reader (by removing the one or more security screws using a security tool) for subsequent servicing, repairing, updating, replacing, or any other need.

In some cases, the example payment card reader described above with reference to FIGS. 2 and 3 can process payments from users regardless of whether the payment card reader is connected to an internet connection. For example, when the payment card reader is connected to the internet, payment settlement can be facilitated by a communication module that can communicate a user or vehicle identifier (or other payment processing information) to one or more third-party servers or systems. In contrast, when the payment card reader is not connected to the internet, offline transactions can still be facilitated by authenticating the payment information locally and holding the payment information until an internet connection is established.

In some examples, offline authentication can be accomplished using the X.509 public key infrastructure standard for verification. An X.509 certificate is a digital certificate that uses the international X.509 public key infrastructure standard to verify that a public key belongs to the user. Any other techniques for offline authentication can also be used. Once an internet connection has been secured, the payment information can be communicated to one or more third-party servers or systems for settlement. Payment information can be communicated individually, or in batches to one or more third-party servers or systems for settlement. In this respect, the example payment card readers can remain operational without a persistent internet connection.

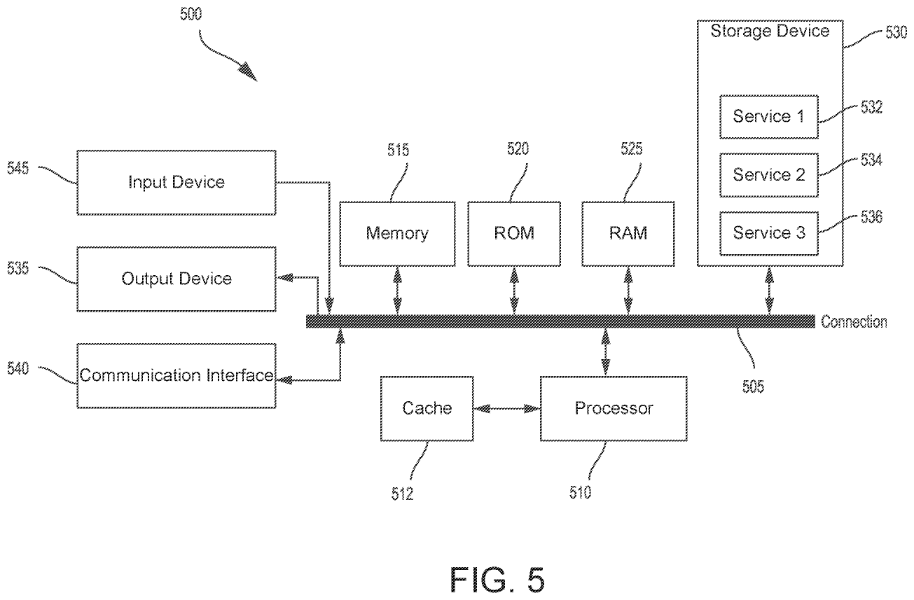

FIG. 5 illustrates an example processor-based system with which some aspects of the subject technology can be implemented. For example, processor-based system 500 can be any computing device making up, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (Central Processing Unit (CPU) or processor) 510 and connection 505 that couples various system components including system memory 515, such as Read-Only Memory (ROM) 520 and Random-Access Memory (RAM) 525 to processor 510. Computing system 500 can include a cache of high-speed memory 512 connected directly with, in close proximity to, or integrated as part of processor 510.

Processor 510 can include any general-purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 540 may also include one or more Global Navigation Satellite System (GNSS) receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 530 can include software services, servers, services, etc., that when the code that defines such software is executed by the processor 510, it causes the system 500 to perform a function. In some embodiments, a hardware service that performs a particular function can include the software component stored in a computer-readable medium in connection with the necessary hardware components, such as processor 510, connection 505, output device 535, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### SELECTED EXAMPLES

Illustrative examples of the disclosure include:

Aspect 1. An electric vehicle supply equipment (EVSE) comprising: a housing; a port disposed in at least one surface of the housing; and a payment reader disposed within the housing via the port, wherein the payment reader is mechanically removable from an exterior of the housing using a security tool.

Aspect 2. The electric vehicle supply equipment (EVSE) of Aspect 1, wherein the payment reader comprises at least one of a credit card chip reader and a contactless credit card reader.

Aspect 3. The electric vehicle supply equipment (EVSE) of Aspect 2, wherein the credit card chip reader is connected to the payment reader using one or more security screws; and the one or more security screws are removable from an outside surface of the credit card chip reader using a security tool.

Aspect 4. The electric vehicle supply equipment (EVSE) of Aspect 2, wherein the contactless credit card reader comprises a near-field communication (NFC) protocol.

Aspect 5. The electric vehicle supply equipment (EVSE) of any of Aspects 1 to 4, wherein the payment reader is connected to the housing of the EVSE using one or more security screws; and the one or more security screws are removable from an outside surface of the payment reader using a security tool.

Aspect 6. The electric vehicle supply equipment (EVSE) of Aspect 5, wherein the payment reader includes a shielding cover that covers the one or more security screws.

Aspect 7. The electric vehicle supply equipment (EVSE) of any of Aspects 1 to 6, wherein the payment reader receives electrical power from the EVSE.

Aspect 8. The electric vehicle supply equipment (EVSE) of any of Aspects 1 to 7, wherein the payment reader comprises a tamper detection device.

Aspect 9. The electric vehicle supply equipment (EVSE) of any of Aspects 1 to 8, wherein the payment reader is configured to transmit payment information to a payment gateway.

Aspect 10. The electric vehicle supply equipment (EVSE) of any of Aspects 1 to 9, wherein the payment reader is configured to comport with an IP67 waterproof standard.

Aspect 11. A method of manufacturing an electric vehicle supply equipment (EVSE) comprising: manufacturing a port disposed in at least one surface of a housing of the EVSE; and manufacturing a payment reader disposed within the housing via the port, wherein the payment reader is mechanically removable from an exterior of the housing using a security tool.

Aspect 12. The method of manufacturing an electric vehicle supply equipment (EVSE) of Aspect 11, wherein the payment reader comprises at least one of a credit card chip reader and a contactless credit card reader.

Aspect 13. The method of manufacturing an electric vehicle supply equipment (EVSE) of Aspect 12, wherein the credit card chip reader is connected to the payment reader using one or more security screws; and the one or more security screws are removable from an outside surface of the credit card chip reader using a security tool.

Aspect 14. The method of manufacturing an electric vehicle supply equipment (EVSE) of Aspect 12, wherein the contactless credit card reader comprises a near-field communication (NFC) protocol.

Aspect 15. The method of manufacturing an electric vehicle supply equipment (EVSE) of any of Aspects 11 to 14, wherein the payment reader is connected to the housing of the EVSE using one or more security screws; and the one or more security screws are removable from an outside surface of the payment reader using a security tool.

Aspect 16. The method of manufacturing an electric vehicle supply equipment (EVSE) of Aspect 15, wherein the payment reader includes a shielding cover that covers the one or more security screws.

Aspect 17. The method of manufacturing an electric vehicle supply equipment (EVSE) of any of Aspects 11 to 16, wherein the payment reader receives electrical power from the EVSE.

Aspect 18. The method of manufacturing an electric vehicle supply equipment (EVSE) of any of Aspects 11 to 17, wherein the payment reader comprises a tamper detection device.

Aspect 19. The method of manufacturing an electric vehicle supply equipment (EVSE) of any of Aspects 11 to 18, wherein the payment reader is configured to transmit payment information to a payment gateway.

Aspect 20. The method of manufacturing an electric vehicle supply equipment (EVSE) of any of Aspects 11 to 19, wherein the payment reader is configured to comport with an IP67 waterproof standard.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. An electric vehicle supply equipment (EVSE) comprising:
a housing;
a port disposed in at least one surface of the housing; and
a payment reader disposed within the housing via the port, wherein the payment reader is mechanically removable from an exterior of the housing using a security tool.

2. The electric vehicle supply equipment (EVSE) of claim 1, wherein the payment reader comprises at least one of a credit card chip reader and a contactless credit card reader.

3. The electric vehicle supply equipment (EVSE) of claim 2, wherein the credit card chip
reader is connected to the payment reader using one or more security screws; and
the one or more security screws are removable from an outside surface of the credit card chip reader using a security tool.

4. The electric vehicle supply equipment (EVSE) of claim 2, wherein the contactless credit card reader comprises a near-field communication (NFC) protocol.

5. The electric vehicle supply equipment (EVSE) of claim 1, wherein the payment reader is
connected to the housing of the EVSE using one or more security screws; and
the one or more security screws are removable from an outside surface of the payment reader using a security tool.

6. The electric vehicle supply equipment (EVSE) of claim 5, wherein the payment reader includes a shielding cover that covers the one or more security screws.

7. The electric vehicle supply equipment (EVSE) of claim 1, wherein the payment reader receives electrical power from the EVSE.

8. The electric vehicle supply equipment (EVSE) of claim 1, wherein the payment reader comprises a tamper detection device.

9. The electric vehicle supply equipment (EVSE) of claim 1, wherein the payment reader is configured to transmit payment information to a payment gateway.

10. The electric vehicle supply equipment (EVSE) of claim 1, wherein the payment reader is configured to comport with an IP67 waterproof standard.

11. A method of manufacturing an electric vehicle supply equipment (EVSE) comprising:
manufacturing a port disposed in at least one surface of a housing of the EVSE; and
manufacturing a payment reader disposed within the housing via the port, wherein the payment reader is mechanically removable from an exterior of the housing using a security tool.

12. The method of manufacturing an electric vehicle supply equipment (EVSE) of claim 11,
wherein the payment reader comprises at least one of a credit card chip reader and a contactless credit card reader.

13. The method of manufacturing an electric vehicle supply equipment (EVSE) of claim 12,
wherein the credit card chip reader is connected to the payment reader using one or more security screws; and
the one or more security screws are removable from an outside surface of the credit card chip reader using a security tool.

14. The method of manufacturing an electric vehicle supply equipment (EVSE) of claim 12, wherein the contactless credit card reader comprises a near-field communication (NFC) protocol.

15. The method of manufacturing an electric vehicle supply equipment (EVSE) of claim 11, wherein the payment reader is connected to the housing of the EVSE using one or more security screws; and
the one or more security screws are removable from an outside surface of the payment reader using a security tool.

16. The method of manufacturing an electric vehicle supply equipment (EVSE) of claim 15, wherein the payment reader includes a shielding cover that covers the one or more security screws.

17. The method of manufacturing an electric vehicle supply equipment (EVSE) of claim 11, wherein the payment reader receives electrical power from the EVSE.

18. The method of manufacturing an electric vehicle supply equipment (EVSE) of claim 11, wherein the payment reader comprises a tamper detection device.

19. The method of manufacturing an electric vehicle supply equipment (EVSE) of claim 11, wherein the payment reader is configured to transmit payment information to a payment gateway.

20. The method of manufacturing an electric vehicle supply equipment (EVSE) of claim 11, wherein the payment reader is configured to comport with an IP67 waterproof standard.
